(19) United States
(12) Patent Application Publication
(10) Pub. No.: US 2005/0259543 A1
(43) Pub. Date: Nov. 24, 2005

(54) Write processing method and optical disc drive

(76) Inventor: Tetsuro Kino, Tokyo (JP)

Correspondence Address: DICKSTEIN SHAPIRO MORIN & OSHINSKY LLP, 2101 L Street, NW, Washington, DC, 20037, US

(21) Appl. No.: 11/131,405

(22) Filed: May 18, 2005

(30) Foreign Application Priority Data
May 20, 2004 (JP) 2004-150329

(51) Int. Cl. G11B 7/00

(52) U.S. Cl. 369/53.17; 369/53.12; 369/53.1

(57) ABSTRACT

A write processing method and an optical disc drive, whereby the control technology for recording information avoids defects on a recording surface of the optical disc during recording.

### BACKGROUND OF THE INVENTION

1. Field of the Invention

The present invention generally relates to a write processing method and an optical disc drive, whereby the control technology records information while avoiding defects on a recording surface of the optical disc.

2. Description of the Background Art

In a writable optical disc, when there was a defect area having a size greater than a recording operation guarantee in the recording surface of an optical disc, an optical disc drive cannot perform servo control. As a result, the optical disc drive fails to record information to the optical disc.

For a write once type of optical disc, where it is possible to record information once on the disc, the optical disc drive does not perform a retry process. Instead, the drive performs post processing to be only accessible for a previously recorded area (i.e., a write enabled area) 20 as illustrated in FIG. 6. For this reason, an area “ahead” of the recordable area (i.e., a write disabled area) 23 was not able to be used due to the defect area 22 in the optical disc 21.

For rewritable optical discs, which record using phase change technology, when a record error occurs in a defect area, the optical disc drive performs re-try processing at the sector address where the error occurred.

In addition, as described in Japanese Laid-Open Patent Application No. 9-270175, the defect area on the optical disc is detected. When the defect is detected, the optical disc drive outputs that fact (i.e., error occurred) to a host device. Furthermore, it is suggested that the problem with the defect area is solved by recording dummy data.

In the background art, for write once optical discs, when a record error occurs due to a defect area, if there is a writable area beyond the defect area, the optical disc drive cannot continue writing to the writable area beyond the defect area.

In addition, for example, when a television broadcast is received and is recorded as a video picture to the optical disc, a continuousness of the video picture data becomes important in order to guarantee reliability of the recorded data. However, when using the rewritable optical disc, if the retry process is performed when the recording error due to the defect area occurs, there will be an omission of time from the broadcast data caused by the retry process, which is undesirable.

### SUMMARY OF THE INVENTION

The object of the present invention solves the afore-mentioned problems of the background art. When a recording error occurs due to a defect area on the disc, if it is a situation where data is input continuously, an omission of time in the recorded data is substantially prevented by a concise technique.

Another object of the present invention is to provide a record processing method, an optical disc drive and a recording medium for an optical disc making it possible to continue a recording operation beyond a defect area.

### BRIEF DESCRIPTION OF THE DRAWINGS

A more complete appreciation of the present invention and many of the attendant advantages thereof will be readily obtained as the same becomes better understood by reference to the following detailed description when considered in connection with the accompanying drawings, wherein:

FIG. 1 is a block diagram of an optical disc drive according to the present invention;

FIG. 2 is a flow chart of recording process according to a first embodiment of the present invention;

FIG. 3 is a flow chart of recording process according to a second embodiment of the present invention;

FIG. 4 is a flow chart of specific example for steps of servo recovering process according to a second embodiment of the present invention;

FIG. 5 illustrates an optical disc after data is recorded beyond the defect area in the optical disc according to an embodiment of the present invention; and

FIG. 6 illustrates an optical disc having a defect area according to the background art.

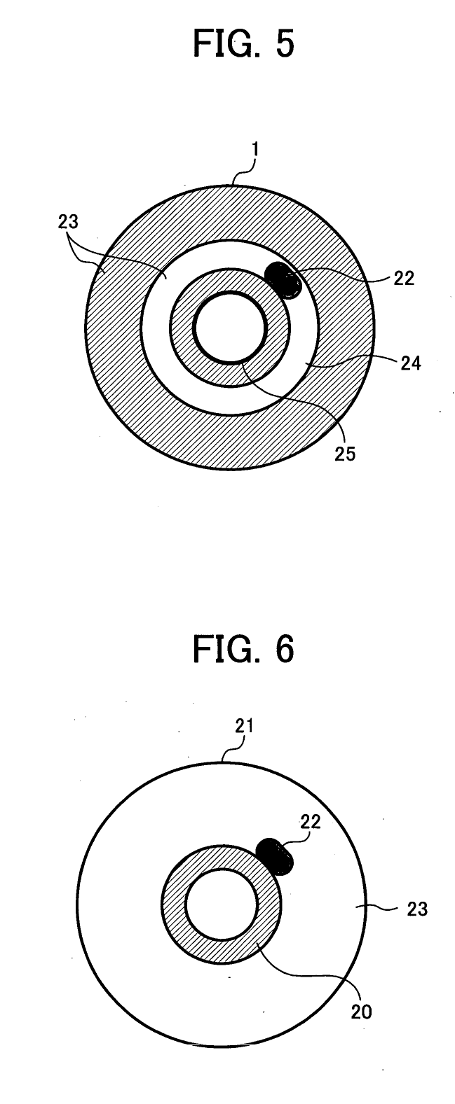

### DETAILED DESCRIPTION OF THE PREFERRED EMBODIMENTS

A description will now be given, with reference to drawings of embodiments of the present invention in which like reference numerals indicate identical or corresponding parts throughout the several views.

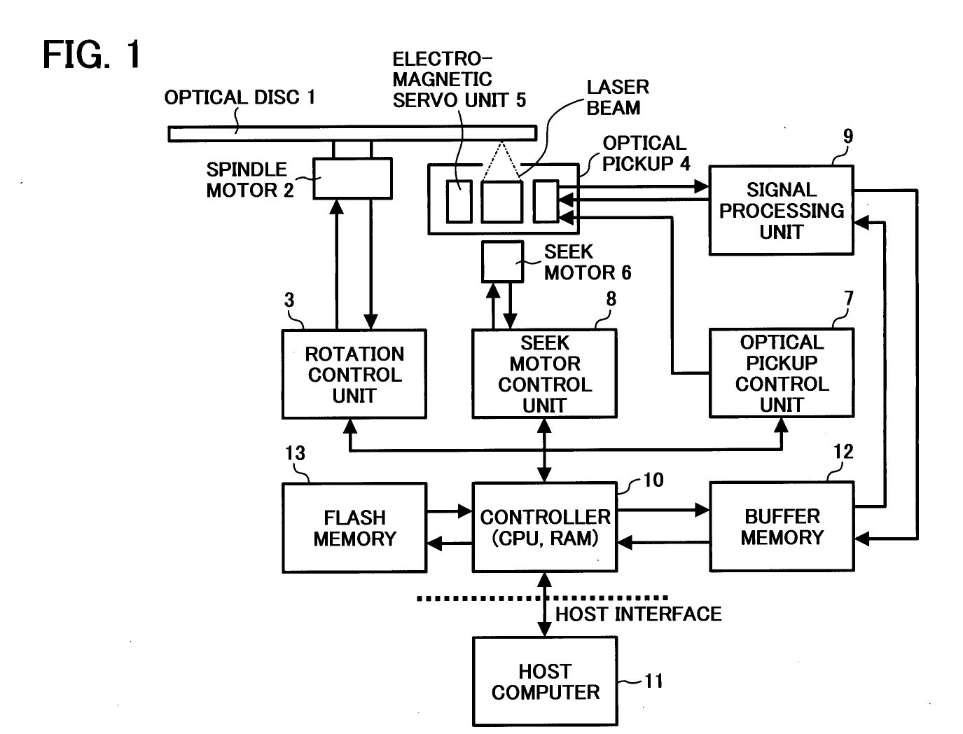

FIG. 1 is a block diagram of an optical disc drive according to the present invention. The optical disc drive as an embodiment of the present invention includes a spindle motor 2 that rotates an optical disc 1 such as e.g., CD, CD-R, CD-RW, DVD, DVD+R, DVD+RW, DVD−R, and DVD−RW discs, an optical pickup 4 having a semiconductor laser that applies a laser beam to a recording region of the optical disc 1 and also having an electromagnetic servo unit 5 to drive an object lens in a focusing direction and a tracking direction, and a seek motor 6 that actuates the optical pickup 4 in the radial direction of the optical disc 1.

The optical disc drive shown in FIG. 1 is further provided with a rotation control unit 3 that controls the rotation of the motor 2, a seek motor control unit 8 that activates the seek motor 6, an optical pickup control unit 7 that controls the optical pickup 4, and a signal processing unit 9 that processes a signal read by the optical pickup 4 from the recording region of the optical disc 1 and a signal to be written by the optical pickup 4 in the recording region of the optical disc 1. In addition, the signal processing unit 9 generates signals for example, an RF signal, a focusing control signal or a tracking control signal.

The optical disc drive shown in FIG. 1 is further provided with a buffer memory 112 that temporarily stores data read from the optical disc 1, and a controller 160 consisting of electronic components such as a CPU and a RAM, that perform various processing in connection with the present invention as well as the controlling of the other control units 3, 7, and 8 and the signal processing unit 9. The controller 10 is connected with a host computer 11 through an external interface so that the controller 10 transmits user data read from the optical disc 1 to the host computer 11 in response to a request from the host computer 11 and receives user data to be written to the optical disc 1 from the host computer 11. A flash ROM memory 13 includes control programs used by the controller 10.

In a communication between the optical drive and the host computer 11, the optical disc drive receives a command from the host computer 11 and sends a response for the command to the host computer 11. If necessary, data is also received or sent between the optical drive and the host computer 11. In addition, it is possible that the optical drive is updated with a control program by the host computer 11.

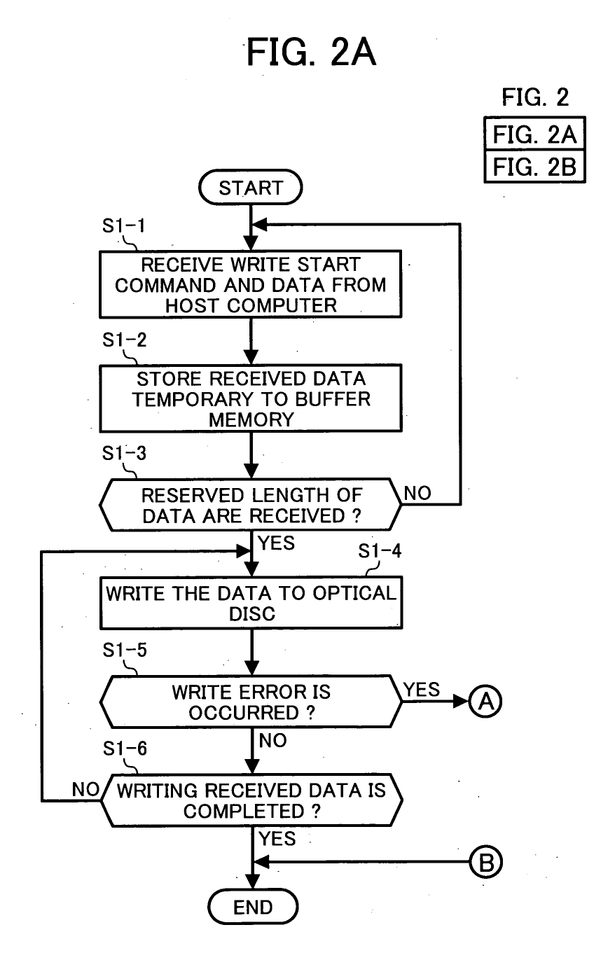

FIG. 2 is a flowchart of a recording process according to a first embodiment of the present invention. The optical disc drive receives a write start command and data for writing from the host computer 11 through the host interface (step S1-1). The received data is stored temporary to the buffer memory 12 (S1-2). When the amount of the received data in the buffer memory 12 reaches a predetermined amount (“Yes” at step S1-3), a write process to the optical disc 1 is started as shown in step S1-4. While information is being written to the disc, the optical disc drive sends a response for the received write command to the host computer 11. The response indicates that the write process is finished normally. The optical disc drive writes the data to the optical disc normally and continuously (“No” of step S1-5), and after the optical disc drive writes all data to the optical disc (step S1-6), the writing process is completed.

After the writing process started, if there is a defect area on a recording surface of the optical disc 1, a write error has occurred (step S1-5) with a servo error on the focusing servo control or the tracking servo control. For this problem, the controller 10 detects a reduced amount of reflection light of the laser beam emitted from the optical pickup 4 at the optical disc 1. If the amount of reflection light is reduced by a predetermined amount, the optical disc drive will stop the writing process.

The controller 10 generates NWA (Next Writable Address) after the error is detected. More specifically, the controller 10 generates an address (NWA) by adding a predetermined address (i.e., offset) for the sector address where the error occurred (step S1-7). The optical disc drive reports the error with the NWA to the host computer 11 (step S1-8).

When the host computer 11 sends the next write command and data for writing after the error is detected (“No” of step S1-9), the controller 10 makes the seek motor controlling unit 8 drive the seek motor 6 to move the optical pickup 4 to the NWA (step S1-10). The controller 10 performs error detection processing at least one rotation from this address. In addition, the controller 10 performs servo recovery for a predetermined number of times until the servo status becomes stable.

If there is no error during the above described process (“No” of step S1-11), the writing process completes after writing a sector address, where the error occurred, and a sector address, which is a starting address for writing correctly after the error occurred, to a management data writing area allocated in the optical disc 1 (step S1-12). According to the process of the present invention, it becomes possible to write continuously over (i.e., beyond) the defect area on the disc.

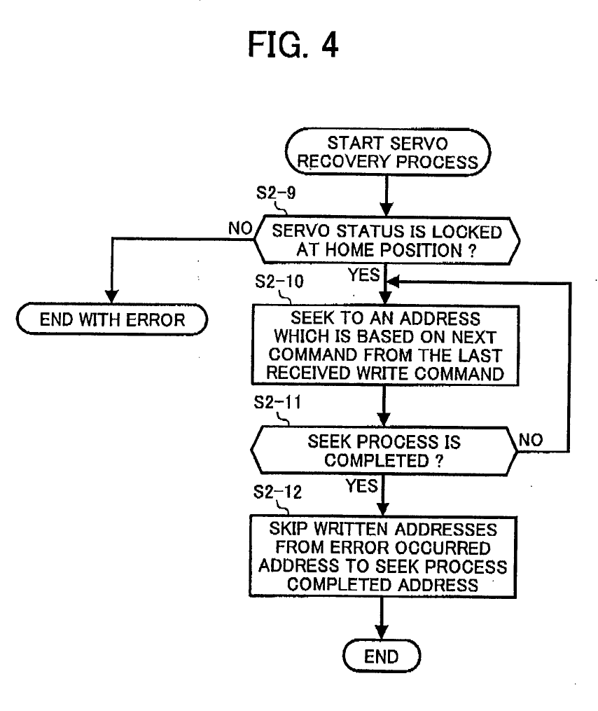

FIG. 5 illustrates an optical disc 1 after data is recorded by skipping over the defect area 22 in the optical disc 1 according to an embodiment of the present invention. A circumferential area including the defect area 22 becomes a write disabled area 24. It is possible, however, that an inner area and an outer area of the circumferential area surrounding the defect area 22 becomes a write enabled area 23. Since the management data writing error 25 includes the sector address where the error occurred and the sector address for the starting address to write correctly after the error occurred, it is possible to retrieve written data from the write enabled area 23 allocated with the inner area and the outer area of the circumferential area including the defect area 22.

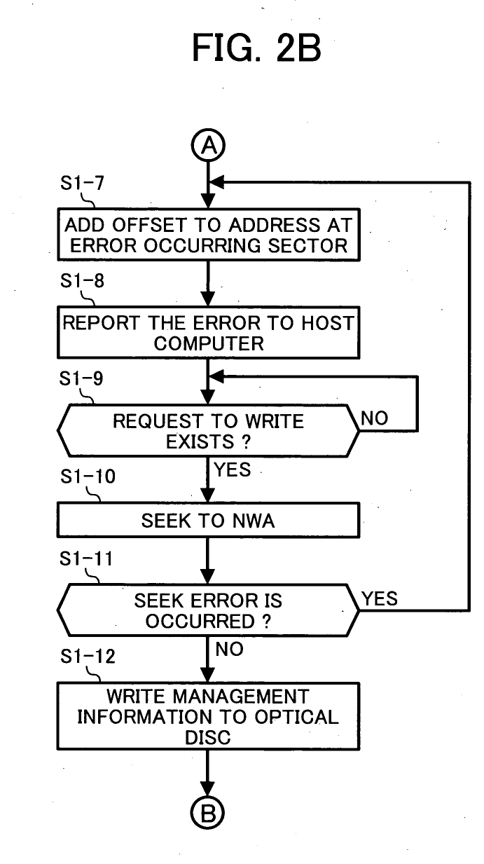

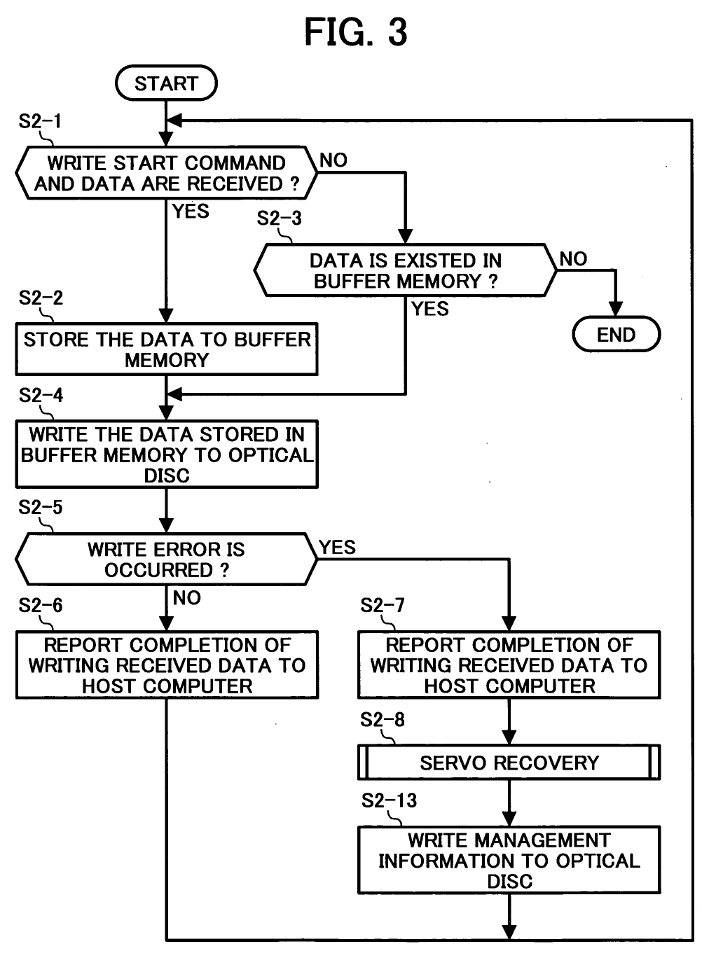

FIG. 3 is a flowchart of a recording process according to a second embodiment of the present invention. FIG. 4 is a flowchart of a specific example for the steps performed in a servo recovering process according to the second embodiment of the present invention.

According to the writing process of FIG. 3, the optical disc drive receives a write command and data for writing from host computer 11 through the host interface (step S2-1). The received data is stored temporary to the buffer memory 12 (step S2-2). When the amount of the received data in the buffer memory 12 reaches a predetermined amount (“Yes” at step S2-3), the data stored in the buffer memory 12 is written to the disc (step S2-4).

The optical disc drive writes the data to the optical disc normally and continuously (“No” at step S2-5), and after the optical disc drive writes all data to the optical disc, the writing process is completed and the optical disc drive send response to the host computer (step S2-6). If, however, the controller 10 finds the defect area on the recording surface on the optical disc 1 (“Yes” at step S2-5), the optical disc drive sends a response to the host computer 11 indicating a completion of the data writing (step S2-7). After the writing process started, if there is a defect area on a recording surface of the optical disc 1, a write error has occurred with either a servo error on the focusing servo control or the tracking servo control. For this problem, the controller 10 detects a reduced amount of reflection light of the laser beam emitted from the optical pickup 4 at the optical disc 1. If the error is detected, the controller 10 does servo recovery processing (step S2-8) an example of which is shown in FIG. 4.

As shown in FIG.4, in the servo recovery process, the controller 10 makes the seek motor controlling unit 8 drive the seek motor 6 to move the optical pickup 4 to a home position and start servo control. After the servo process becomes stable (“Yes” at step S2-9), the controller 10 makes the seek motor controlling unit 8 drive the seek motor 6 to move the optical pickup 4 to an address including the last received command (step S2-10), and the controller 10 performs servo recovery until the seek status becomes stable (“Yes” at step S2-11).

In this case, the data received from the host computer 11 is not written to the optical disc 1 and is discarded; the optical disc drive skips addresses from where the error occurred until the servo status becomes stable (step S2-12).

After the servo recovers, the writing process writes a sector address where the error occurred and a sector address which serves as a starting address for writing correctly after the error occurred to a management data writing area allocated on the optical disc 1 (S2-13). The process continues at step S2-1, where the writing process writes the next data received from the host computer 11 continuously over/beyond the defect area.

As above described, when the optical disc drive detects the defect area, the optical disc drive skips writing data received while the error is occurring, but the optical disc sends a “no error” response to the host computer 11. This way, the host computer 11 sends the write command and the write data continuously. However, if the address of last received data and the address of currently received data are not continuous, the last received data and currently received data are not continuous, and so the optical disc drive does not skip the writing.

This application claims priority to Japanese Patent Application No. 2004-150329, filed May 20, 2004, which is herby incorporated by reference herein.

The processes and devices described above illustrate preferred methods and typical devices of many that could be used and produced. The above description and drawings illustrate embodiments, which achieve the objects, features, and advantages of the present invention. However, it is not intended that the present invention be strictly limited to the above-described and illustrated embodiments. Any modification, though presently unforeseeable, of the present invention that comes within the spirit and scope of the following claims should be considered part of the present invention.

1. A write processing method for an optical disc comprising the steps of:
detecting a write error,
creating a next writable address based on an address of a sector where the write error occurred and an address beyond a defect area where said write error occurred, and
writing to an area offset from said defect area.

2. The write processing method as claimed in claim 1,
wherein the address beyond the defect area is an address created by adding the address of the sector where the write error occurred and a predetermined address offset.

3. The write processing method as claimed in claim 1,
wherein the address beyond the defect area is an address using an address included with received data from a host computer after the write error occurred.

4. The write processing method as claimed in claim 3 further comprising the step of discarding the received data received while the error is occurring.

5. The write processing method as claimed in claim 1 further comprising the step of sending a response to the host computer so the host computer ignores the write error.

6. The write processing method as claimed in claim 1 further comprising the step of detecting the defect area at least one rotation from the address of the next writable address.

7. The write processing method as claimed in claim 1 further comprising the step of writing a sector address where the write error occurred and a sector address for a starting address for writing correctly after the error occurred to a management data writing area allocated on the optical disc.

8. The write processing method as claimed in claim 1 further comprising the step of performing servo recovery processing for a predetermined number of times until a servo status become stable.

9. A write processing method for optical disc comprising:
a step for detecting a write error,
a step for creating a next writable address based on an address of a sector where the write error occurred and an address beyond a defect area where said write error occurred, and
a step for writing to an area offset from said defect area.

10. The write processing method as claimed in claim 9,
wherein the address beyond the defect area is an address created by adding the address of the sector where the write error occurred and a predetermined address offset.

11. The write processing method as claimed in claim 9,
wherein the address beyond the defect area is an address using an address included with received data from a host computer after the write error occurred.

12. The write processing method as claimed in claim 11 further comprising a step for discarding the received data received while the error is occurring.

13. The write processing method as claimed in claim 9 further comprising a step for sending a response to the host computer so the host computer ignores the write error.

14. The write processing method as claimed in claim 9 further comprising a step for detecting the defect area at least one rotation from the address of the next writable address.

15. The write processing method as claimed in claim 9 further comprising a step for writing a sector address where the write error occurred and a sector address for a starting address for writing correctly after the error occurred to a management data writing area allocated on the optical disc.

16. The write processing method as claimed in claim 9 further comprising the step of performing servo recovery processing for a predetermined number of times until a servo status become stable.

17. An optical disc drive configured to write data to an optical disc comprising:
a detecting apparatus that detects a write error,
a next writable address generating apparatus that generates a next writable address based on an address of a sector where the write error occurred and an address beyond a defect area where said write error occurred, and
a controlling apparatus that writes to an area offset from said defect area.

18. The optical disc drive as claimed in claim 17,
wherein the address beyond the defect area is an address created by adding the address of the sector where the write error occurred and a predetermined address offset.

19. The optical disc drive as claimed in claim 17,
wherein the address beyond the defect area is an address using an address included with received data from a host computer after the write error occurred.

20. The optical disc drive as claimed in claim 19,
wherein the controlling apparatus discards the received data received while the error is occurring.

21. The optical disc drive as claimed in claim 17,
wherein the controlling apparatus sends a response to the host computer so the host computer ignores the write error.

22. The optical disc drive as claimed in claim 17,
wherein the detecting apparatus detects the defect area at least one rotation from the address of the next writable address.

23. The optical disc drive as claimed in claim 17,
wherein the controlling apparatus writes a sector address where the write error occurred and a sector address for a starting address for writing correctly after the error occurred to a management data writing area allocated on the optical disc.

24. The optical disc drive as claimed in claim 17,
wherein the controlling apparatus performs servo recovery processing for a predetermined number of times until a servo status become stable.

25. An optical disc drive configured to write an optical disc comprising:
detecting means for detecting that a write error occurred,
a next writable address generating means for generating a next writable address based on an address of a sector where the write error occurred and an address beyond a defect area where said write error occurred, and
a controlling means for writing to an area offset from said defect area.

26. The optical disc drive as claimed in claim 25,
wherein the address beyond the defect area is an address created by adding the address of the sector where the write error occurred and a predetermined address offset.

27. The optical disc drive as claimed in claim 25,
wherein the address beyond the defect area is an address using an address included with received data from a host computer after the write error occurred.

28. The optical disc drive as claimed in claim 27,
wherein the controlling means discards the received data received while the error is occurring.

29. The optical disc drive as claimed in claim 25,
wherein the controlling means sends a response to the host computer so the host computer ignores the write error.

30. The optical disc drive as claimed in claim 25,
wherein the detecting means detects a defect area at least one rotation from the address of the next writable address.

31. The optical disc drive as claimed in claim 25,
wherein the controlling means writes a sector address where the write error occurred and a sector address for a starting address for writing correctly after the error occurred to a management data writing area allocated on the optical disc.

32. The optical disc drive as claimed in claim 25,
wherein the controlling means performs servo recovery processing for a predetermined number of times until a servo status become stable.
